(19) United States
(12) Patent Application Publication
(10) Pub. No.: US 2006/0087674 A1
(43) Pub. Date: Apr. 27, 2006

(54) Document and information deficiency processing system

(76) Inventors: William D. Lusen, East Norriton, PA (US); Frank W. Racis, Spring City, PA (US); Andres Hernandez, Downingtown, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/201,586

(22) Filed: Aug. 11, 2005

Related U.S. Application Data
(60) Provisional application No. 60/622,068, filed on Oct. 26, 2004.

(51) Int. Cl. G06K 15/00

(52) U.S. Cl. 358/1.14

(57) ABSTRACT

A document processing system links and chains data identifying document deficiencies together for use in monitoring document completion to control workflow and automate document completion. A document processing system includes at least one repository including chain data identifying, multiple document deficiencies, individual document deficiency type and an order for addressing the document deficiencies for providing completed documents. A task processor uses the at least one repository in automatically assigning tasks to be performed by one or more workers in the order for addressing the document deficiencies to correct the deficiencies.

This is a non-provisional application of provisional application Ser. No. 60/622,068 by W. Lusen et al. filed Oct. 26, 2004.

### FIELD OF THE INVENTION

This invention concerns a system for identifying and managing document deficiencies and monitoring document or record completion to control workflow and automate a document completion process.

### BACKGROUND INFORMATION

One of the purposes of a Healthcare Information Management (HIM) department of a hospital is to ensure that medical records are complete. The process used to achieve this is termed “record completion”. Computerization can help to automate the record completion process, which involves a workflow that ensures that a record contains required documents and that the documents are neither missing information nor contain inaccurate information. Existing systems are available that automate the completion process, however, these systems are typically based on work queues. A work queue based workflow is difficult for a user to customize and is not readily adapted to manage exception conditions and exception workflows. Managing such exception conditions is typically complicated and queue based workflows of existing systems require scripting or script-like development. A work queue based workflow is difficult for a user to customize and is difficult to modify to extend existing functionality. A system according to invention principles addresses these inadequacies and associated problems.

### SUMMARY OF THE INVENTION

A system identifies document (record) deficiencies and manages and chains them together in monitoring document or record completion to control workflow and automate a document completion process. A document processing system includes at least one repository including chain data identifying, multiple document deficiencies, individual document deficiency type and an order for addressing the document deficiencies for providing completed documents. A task processor uses the at least one repository in automatically assigning tasks to be performed by one or more workers in the order for addressing the document deficiencies to correct the deficiencies.

### BRIEF DESCRIPTION OF THE DRAWING

FIG. 1 shows a document processing system involving document deficiency management, according to invention principles.

FIG. 2 shows a table illustrating document deficiency types, according to invention principles.

FIG. 3 shows a configuration user interface image window for use in determining deficiency types, according to invention principles.

FIG. 4 shows a user interface image window for alerting a user to a deficiency specifically, to prompt a user to dictate a report, according to invention principles.

FIG. 5 shows a user interface image window for alerting a user to a deficiency specifically, to prompt a user to sign a document, according to invention principles.

FIG. 6 shows a user interface image window enabling a user to establish a deficiency chain for managing document completion, according to invention principles.

FIG. 7 shows a flowchart of a process for processing a document involving document deficiency management, according to invention principles.

### DETAILED DESCRIPTION OF INVENTION

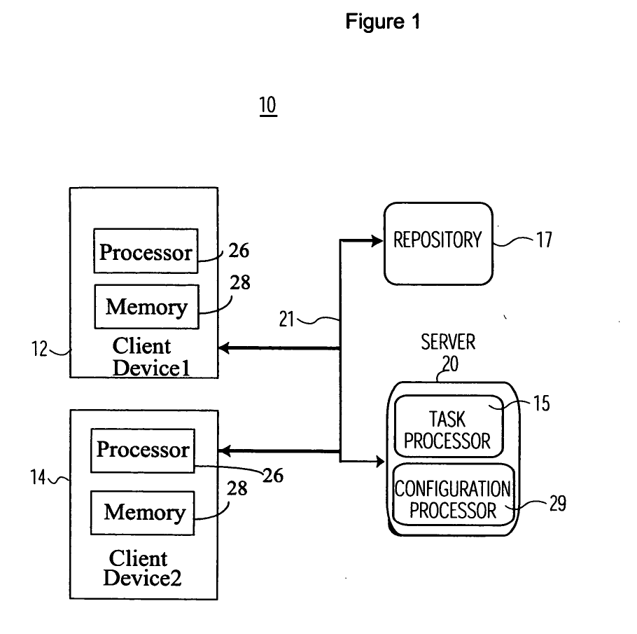

FIG. 1 shows a document processing system involving document deficiency management that advantageously links and chains data indicating deficiencies together in monitoring document or record completion. The system identifies document deficiencies, manages and chains document deficiency indicators together to support workflow control and automate a document completion process. In healthcare it is important to maintain documentation of good quality and this typically involves a review process to ensure that documentation is available and correct. Maintenance of documentation involves monitoring record completion and includes a task sequence workflow to collect documents that are relevant to individual health records and workflows to validate that document information is correct and complete and not omitting vital data.

A record may comprise one or more documents and the term “record” may be used interchangeably with the term “document”. An executable application as used herein comprises code or machine readable instruction for implementing predetermined functions including those of an operating system, healthcare information system or other information processing system, for example, in response user command or input. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device. An object or data object as used herein comprises a grouping of data, executable instructions or a combination of both or an executable procedure. A document or record comprises a compilation of data in electronic form and is the equivalent of a paper document and may comprise a single, self-contained unit of information. It may consist of one or more “pages” of information bound together as a unit. The pages may be stored in any digital format as long as the stored pages can be rendered into a human readable presentation.

As used herein the term child refers to a folder or document that is contained within another folder. This term reflects the relationship of a folder or document with the folder in which it is contained. The term complete refers to a condition achieved by a folder or document when the information contained therein is verified to be accurate and whole. In the case of a document, this means when there is no missing information relevant and necessary to the document and the contained information is substantially accurate. A folder is complete when expected or required documents exist for that folder and documents contained in the folder are complete. A deficiency refers to some condition that makes a folder or document incomplete. For example, a folder may be missing an expected or required document or a document may be missing information or contain inaccurate information. A deficiency chain refers to an ordered series of data indicating deficiencies used to define a task sequence (a workflow) performed by a worker or system to control a record completion process. A deficiency chain comprises data indicating a sequence of deficiencies that needs to be addressed in order to ensure that a record or document is complete.

A folder is a container used to organize documents. Folders can contain zero or more documents and zero or more subfolders. A folder may be considered a parent of documents and subfolders contained within it. The term incomplete is the antonym of complete. A parent refers to a folder in which another folder or document is contained. This term reflects the relationship of a folder to its contents. The term record is an equivalent term for folder and the two terms may be used interchangeably. Record completion refers to the process required to ensure that a folder or document is complete. A subfolder is a folder that is contained within another folder and is a child of another folder. The invention principles are applicable to any business object (i.e. an object in any industry such as an employee in the human resources industry or an account in the banking industry), but is described for exemplary purposes in the context of business objects of documents and records as defined below.

FIG. 1 shows document processing system 10 involving document deficiency management. Document processing system 10 includes client devices 12 and 14, repository 17 and server 20 executing task processing application 15 and configuration application 29. The system 10 devices are interconnected and bidirectionally communicate via network 21 such as a LAN (Local Area Network) or other type of network. A client device 12 or 14 includes processor 26 and memory unit 28 and may comprise a personal computer, for example. A user is able create, maintain and manage deficiency chain data using configuration processor 29 via one or more user interface images displayed on client device 12 or 14. The document processing system 10 may used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. Examples of the people being serviced by the healthcare provider include, without limitation, a patient, a resident, and a client.

Repository 17 (representing one or more distributed repositories) includes chain data identifying, multiple document deficiencies, individual document deficiency type and an order for addressing the document deficiencies for providing completed documents. The document deficiency type and order for addressing the document deficiencies are used by task processor 15 to initiate a method of addressing a deficient condition. Task processing application 15 operating on server 20, uses repository 17 in automatically assigning tasks to be performed by one or more workers in the order for addressing the document deficiencies to correct the deficiencies. A record and the documents contained therein are considered potentially deficient until reviewed by qualified personnel for accuracy and completion. A record or document may be deficient because it is missing vital documents such as an operative report or discharge instructions, it is missing vital information or it contains incorrect information.

Task processor 15 employs a method of addressing a deficient condition comprising an associated task sequence (a workflow) for performance by a system or worker or combination of both for eliminating the deficient condition. In response to task processor 15 addressing one document deficiency condition, a successive deficient condition may arise. In an example, a document may be missing from a medical record of a patient (a dictation deficiency) as indicated by deficiency chain data in repository 17. Task processor 15 in response to the deficiency chain data, automatically assigns a healthcare worker (e.g., a physician) the task of dictating the missing document. In response to dictation of the missing document, it needs to be transcribed into an electronic document (e.g., by being typed or scanned into a word processing application such as MICROSOFT WORD®). Therefore, a transcription deficiency results from satisfying the dictation deficiency.

In response to deficiency chain data indicating a transcription deficiency, task processor 15 automatically assigns the task of transcribing the dictated document into an electronic document to a system or worker. In response to the transcription and associated deficiency chain data indicating an analysis deficiency, task processor 15 automatically assigns the task of analyzing an electronic version of the transcribed document to ensure that vital information is included. Similarly, in response to analysis of the electronic version of the transcribed document and associated deficiency chain data indicating a missing information deficiency, task processor 15 automatically assigns the task of incorporating the missing information in the electronic version of the transcribed document. Further, upon incorporation of the missing information and associated deficiency chain data indicating a review deficiency, task processor 15 automatically assigns the task of reviewing the electronic version of the transcribed document to a knowledgeable person to ensure document accuracy. Following satisfactory review of the transcribed document and in response to associated deficiency chain data indicating a signature deficiency, task processor 15 automatically assigns the task of signing the electronic version of the transcribed document to the reviewer. This task sequence may continue.

A deficiency chain based workflow is readily customized and extended within system 10. A user is advantageously able to create data indicating a chain of deficiencies and new deficiencies without creating executable script or other code. The system facilitates user addition of new deficiencies to a chain and incorporation of them within repository 17 without altering or affecting existing executable code. The system also facilitates user addition of new automated processes to address added deficiencies without altering or affecting existing executable code.

Some deficiency indicators identify that particular document information is missing or incorrect while other deficiency indicators merely identify that a record or document needs to be reviewed for completeness. One attribute of a deficiency indicator is deficiency type. A deficiency type is a categorization that provides information about the purpose of a deficiency and how the deficiency is to be addressed so that it is satisfied. Deficiencies that share the same deficiency type inherit the common properties of a deficiency type definition. A deficiency type is given a name for reference purposes. The name is typically descriptive of the nature of deficiencies of that type. For example, a signature deficiency type is one that indicates a signature is required on a document. A deficiency type is also advantageously associated with a process to address deficiencies of a particular type. For example, a process to address a signature deficiency involves assigning a healthcare worker to review the content of a document and testify, by electronically signing the document, that pertinent information is present and accurate. Additionally, a deficiency type may specify a list of zero or more other types that restrict its being addressed. For example, a signature deficiency type lists a missing information deficiency type as a restrictive type. This means that if there is a missing information deficiency on the same document as a signature deficiency, the missing information deficiency needs to be addressed before the signature deficiency.

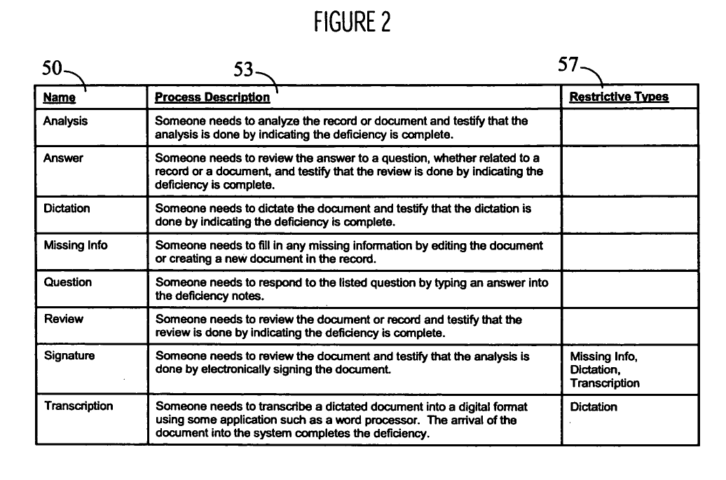

System 10 supports use of an unlimited number of deficiency types and FIG. 2 shows a table illustrating document deficiency types. The FIG. 2 table identifies different deficiency types by name in column 50 with corresponding descriptions of processes used to address the different deficiency types in column 53 and any associated restrictive types being identified in column 57. The different deficiencies illustrated in FIG. 2 include analysis, answer, dictation, missing information, question, review, signature and transcription deficiency types as identified in column 50. Deficiency types may be defined dynamically for use in chains.

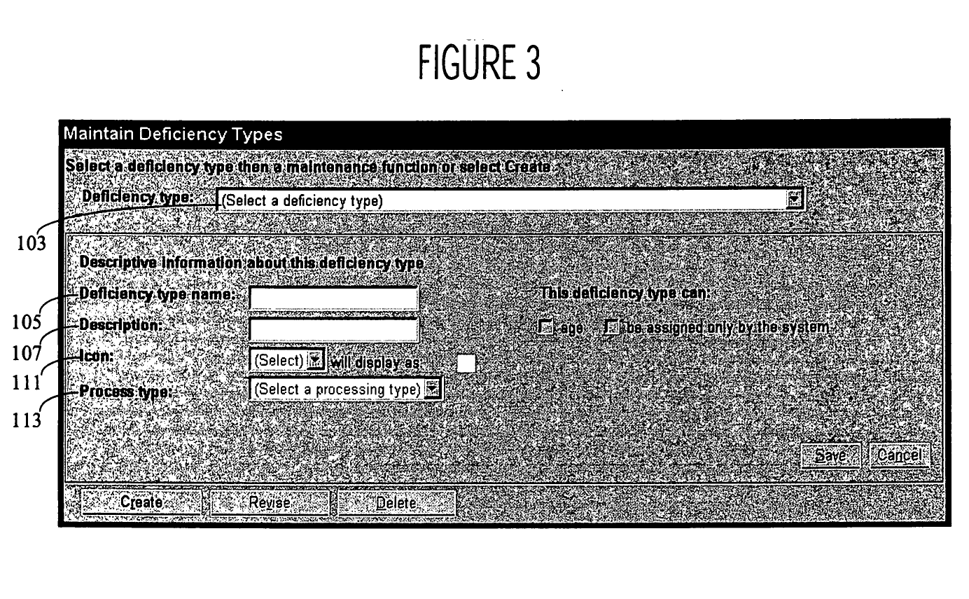

FIG. 3 shows a configuration user interface image window for use in determining deficiency types. A user is able to select and establish a deficiency type via option list 103. In addition a user is able to select a deficiency type name, a deficiency type description, an icon to represent the deficiency type and a process type used to address the selected deficiency type to eliminate this deficiency via menu items 105, 107, 111 and 113 respectively. Deficiencies have multiple attributes other than deficiency type and these may be established using another embodiment of the FIG. 3 image, for example. These other attributes include, for example, a reference to a record or document that is deficient or, if the document is missing, the type of document that is expected. The other attributes also include, data indicating a person who is responsible for addressing the deficiency, a deadline (i.e. due date and time) for addressing the deficiency and an indicator that the deficiency is active (i.e. does not have any restrictive prerequisites).

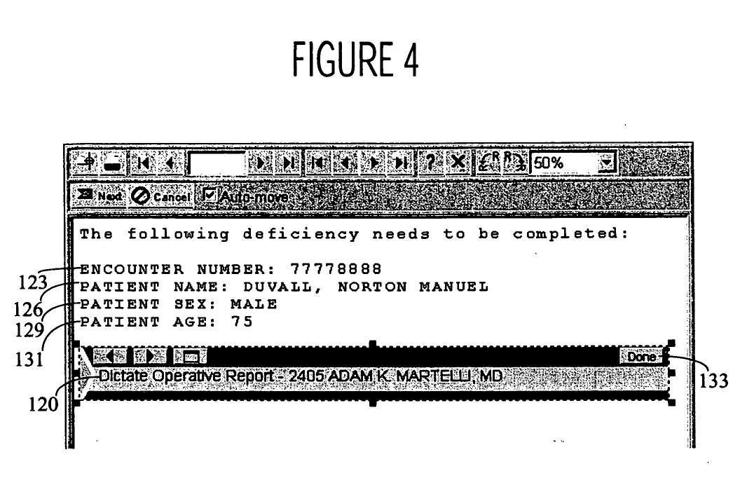

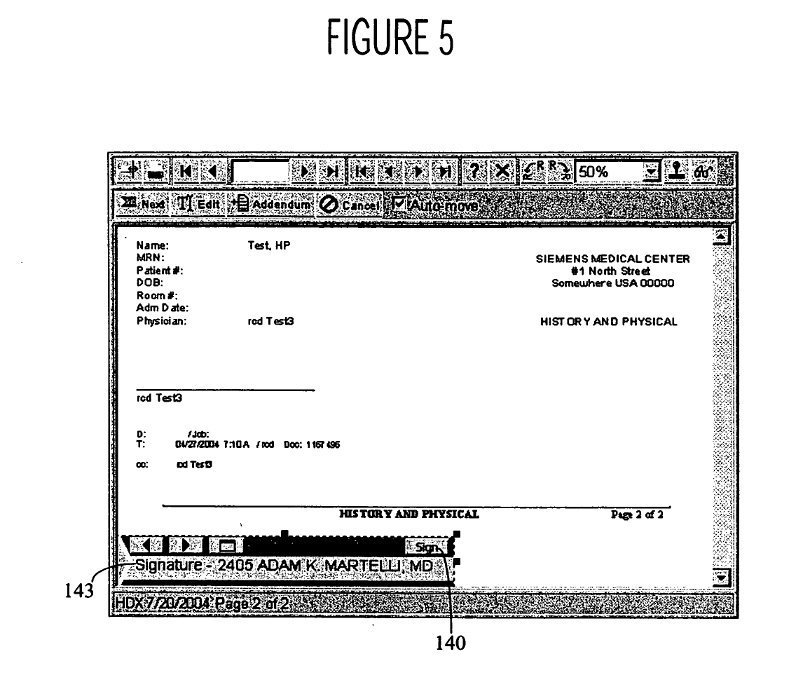

An active deficiency may be presented to a responsible person. FIG. 4 shows a user interface image window for alerting a user to a deficiency and specifically to prompt a user to dictate a report. In the FIG. 4 image, item 120 prompts a user to dictate a missing document. Helpful information is presented in rows 123 to 131 to facilitate the user in performing an action to eliminate a deficiency (here to dictate a missing document). A user selects button 133 to indicate to system 10 that dictation of the missing document is complete. FIG. 5 shows a user interface image window for alerting a user to a deficiency and specifically to prompt a user to sign a document via item 143. A user selects button 140 to electronically sign a document and to testify that a document has been reviewed and information is present and accurate.

Repository 17 incorporates data indicating deficiency chains that are used by system 10 to implement task sequences (workflows) comprising record completion processes. A deficiency chain denotes tasks required to be performed for completion of a document or record and tracks the progress of those tasks. Data indicating a deficiency chain is advantageously created based on a deficiency chain definition to initiate a process to complete a particular document or record. A deficiency chain definition advantageously describes a sequence of deficiencies, by type and in the order the deficiencies need to be addressed to ensure the document or record is complete. A deficiency chain enables system 10 to control a record completion process. A deficiency chain definition is referenced when creating deficiencies for a particular document or record and repository 17 may incorporate data indicating a practically unlimited number of deficiency chain definitions facilitating flexible choice of workflows to complete a document or record. Further, some documents and records may need to address several different chains of deficiencies to achieve completeness.

System 10 supports user selection of multiple sequencing options when defining deficiency chains for storage in repository 17. A simple deficiency chain is a sequential chain in which each deficiency needs to be addressed before the next one may become active. Alternatively, a deficiency chain may define a fork in a process such that completing one deficiency activates several others concurrently thus creating a condition where multiple successive deficiencies are to be concurrently addressed. In some cases, concurrently addressed deficiencies may be interdependent and the completion of one deficiency negates the need to complete another, for example. Below are examples of deficiency chains to illustrate chain types. In an example of a sequential document deficiency chain processed by task processor 15, an individual letter indicates a type of deficiency that needs to be addressed in a predetermined order.
D→T→S

D indicates a dictation deficiency that identifies a required document does not exist and that a responsible worker needs to dictate the information to create the document. Dictation is usually performed using a voice recording mechanism and a worker indicates to system 10 that the dictation is done via data entry. In response to the dictation deficiency being addressed, the T (transcription) deficiency is activated indicating that the dictated document needs to be transcribed. Task processor 15 routes data indicating the deficiency to a transcriptionist (a worker responsible for doing the transcription) so a voice recording may be turned into an electronic document using a work processing application or some other means. The transcription deficiency is completed upon storage of the transcribed document. In response to storage of the transcribed document, the S (signature deficiency) is activated indicating that a worker needs to review the document for accuracy and sign the document thus testifying that the information is present and true.

In another example, a deficiency chain with a fork to two concurrently activated deficiencies is illustrated.

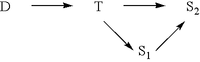

Task processor 15 processes deficiencies indicated by D and T as described in the previous example. However, in response to the T deficiency being addressed, task processor 15 processes this deficiency chain by concurrently activating two S (signature) deficiency tasks. In this example, both signature deficiencies may be addressed, but since S₁ is also defined as a predecessor of S₂, if S₂ is addressed, the need to address S₁ is negated.

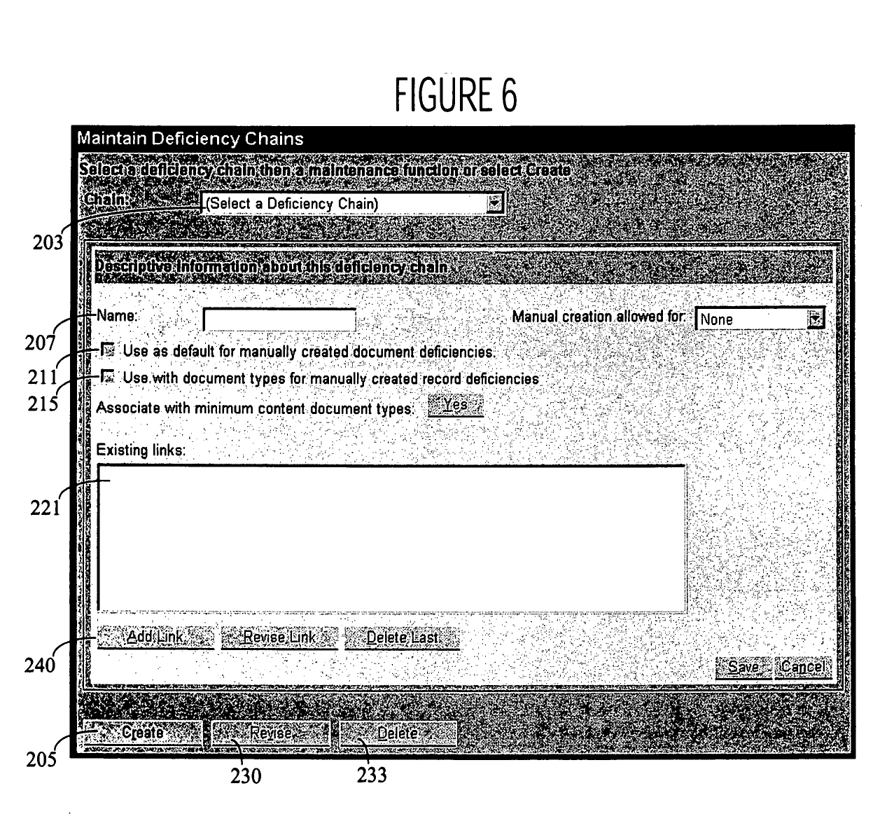

FIG. 6 shows a user interface image window enabling a user to establish a deficiency chain for managing document completion. The FIG. 6 image enables a user to dynamically add and alter deficiency chain definitions for use in record completion. A user is able to select an existing deficiency chain via option list 203 for display in box 221 for editing and alteration. A user is able to create a new deficiency chain by data entry in box 221 or by editing an existing chain shown in box 221 and selecting create button 205. A user can name a deficiency chain via data entry box 207 and add or revise a link or delete a latest entry within a deficiency chain via options in row 240. A user is able to specify a deficiency chain is to be used as a default chain for manually created deficiencies via option 211 and is able to specify a deficiency chain is to be used with document types for manually created record deficiencies via option 215. A user initiates revision of an existing deficiency chain by selection of button 230 and deletes a deficiency chain using button 233. A variety of different user interface images are usable for creating a deficiency chain and the FIG. 6 image is merely an illustration.

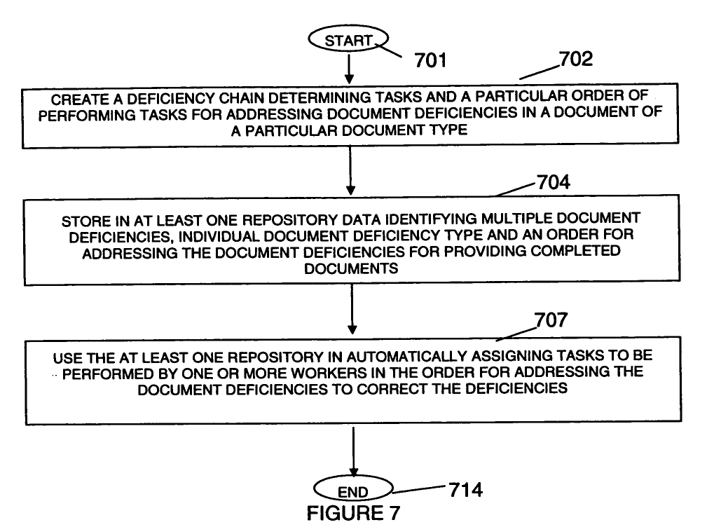

FIG. 7 shows a flowchart of a process employed for processing a document (e.g., a record in a patient electronic medical record) involving document deficiency management and executed by one or more applications operating on server 20 (FIG. 1). In step 702 following the start at step 701, configuration processor 29 (FIG. 1) and an associated user interface display image enables a user to enter and create data (e.g., a data object) indicating a deficiency chain determining tasks and a particular order of tasks for addressing document deficiencies in response to a determined particular document type. In step 704 a repository management application (not shown in FIG. 1) operating on server 20, stores in at least one repository (e.g., repository 17 of FIG. 1) deficiency chain data identifying, a plurality of document deficiencies, individual document deficiency type and an order for addressing the document deficiencies for providing completed documents. The deficiency type indicates at least one of, (a) how a deficiency is to be corrected and (b) the purpose of the deficiency. The order for addressing the document deficiencies in the chain data indicates a particular second document deficiency is to be corrected subsequent to correction of a first document deficiency, of a particular document type.

The at least one repository associates an individual deficiency type with a process to be used by the task processor in correcting an individual deficiency in the order for addressing the document deficiencies and also with a sub-type indicating restrictions on correcting the individual deficiency of the deficiency type. The sub-type indicates at least one of, (a) a particular first deficiency type needs to be corrected before a second deficiency type may be corrected and (b) any one of multiple particular deficiencies need to be corrected before another deficiency may be corrected. The at least one repository also associates an individual deficiency type with a label.

Task processor 15 (FIG. 1) in step 707 uses the at least one repository in automatically assigning tasks to be performed by one or more workers in the order for addressing the document deficiencies to correct the deficiencies. The task processor assigns the tasks in a particular order for addressing the document deficiencies to correct the deficiencies in response to a determined document type. The task processor assigns a task by communicating a message to a worker alerting the worker to perform a particular action or to a system used for scheduling worker tasks to be performed and accessed by the worker following login to the system. The process of FIG. 7 terminates at step 714.

The system, processes and user interface display images presented herein are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the system and process of FIGS. 1 and 7, may be implemented in hardware, software or a combination of both. The invention principles can be extended for use with any workflow related to tracking and addressing document deficiencies. Deficiencies and deficiency chains may be applied to any business object. Deficiency chains in one embodiment are used by a Healthcare Information Management system to implement record completion workflow but may also be used for other workflows related to documents and records in the healthcare or other industries.

What is claimed is:

1. A document processing system, comprising:
at least one repository including chain data identifying, a plurality of document deficiencies, individual document deficiency type and an order for addressing said document deficiencies for providing completed documents; and
a task processor for using said at least one repository in automatically assigning tasks to be performed by one or more workers in said order for addressing said document deficiencies to correct said deficiencies.

2. A system according to claim 1, wherein
said deficiency type indicates at least one of, (a) how a deficiency is to be corrected and (b) the purpose of the deficiency.

3. A system according to claim 1, wherein
said at least one repository associates an individual deficiency type with a process to be used by said task processor in correcting an individual deficiency in said order for addressing said document deficiencies.

4. A system according to claim 1, wherein
said order for addressing said document deficiencies in said chain data indicates a particular second document deficiency to be corrected subsequent to correction of a first document deficiency, of a particular document type.

5. A system according to claim 1, wherein
said chain data comprises a data object.

6. A system according to claim 1, wherein
said task processor assigns said tasks in a particular order for addressing said document deficiencies to correct said deficiencies in response to a determined document type.

7. A system according to claim 6 including
a configuration processor enabling a user to configure said particular order of tasks for addressing said document deficiencies in response to said determined document type.

8. A system according to claim 1, wherein
said at least one repository associates individual deficiency type with a sub-type indicating restrictions on correcting an individual deficiency of said deficiency type in said order for addressing said document deficiencies.

9. A system according to claim 8, wherein
said sub-type indicates at least one of, (a) a particular first deficiency type needs to be corrected before a second deficiency type may be corrected and (b) any one of a plurality of particular deficiencies need to be corrected before another deficiency may be corrected.

10. A system according to claim 1, wherein
said at least one repository associates an individual deficiency type with a label.

11. A system according to claim 1, wherein
said task processor assigns a task by communicating a message to a worker alerting said worker to perform a particular action.

12. A system according to claim 1, wherein
said task processor assigns a task by communicating a message to a system used for scheduling worker tasks to be performed and accessed by said worker following login to said system.

13. A system according to claim 1, wherein
a document is a record in a patient electronic medical record.

14. A method for managing document completion, comprising the activities of:
storing in at least one repository data identifying, a plurality of document deficiencies, individual document deficiency type and an order for addressing said document deficiencies for providing completed documents; and
using said at least one repository in automatically assigning tasks to be performed by one or more workers in said order for addressing said document deficiencies to correct said deficiencies.

15. A patient medical record document processing system, comprising:
at least one repository including chain data identifying, a plurality of patient medical record document deficiencies, individual patient medical record document deficiency type and an order for addressing said patient medical record document deficiencies for providing completed documents; and
a task processor for using said at least one repository in automatically assigning tasks to be performed by one or more workers in said order for addressing said patient medical record document deficiencies to correct said deficiencies.

16. A system according to claim 15 including
a configuration processor and an associated user interface display image enabling a user to enter said chain data.
